(19) United States
(12) Patent Application Publication
(10) Pub. No.: US 2023/0143462 A1
(43) Pub. Date: May 11, 2023

(54) MULTI-CHANNEL CLEANING DEVICE, MULTI-CHANNEL SENSOR CLEANING MODULE, VEHICLE

(71) Applicant: ZF CV Systems Global GmbH, Bern (CH)

(72) Inventor: Janik Ricke, Uetze (DE)

(21) Appl. No.: 18/149,517

(22) Filed: Jan. 3, 2023

Related U.S. Application Data
(63) Continuation of application No. PCT/EP2021/068926, filed on Jul. 8, 2021.

(30) Foreign Application Priority Data
Jul. 23, 2020 (DE) 10 2020 119 475.7

(51) Int. Cl. B60S 1/48; B60S 1/54

(52) U.S. Cl. CPC B60S 1/481; B60S 1/54

(57) ABSTRACT

A multi-channel cleaning device provides a liquid and/or a compressed air flow for cleaning jets and has: a module compressed air connection and a module liquid connection for receiving cleaning liquid. At least two nozzle branches are provided. One nozzle branch is configured for supplying at least one cleaning nozzle independently of another nozzle branch. Each nozzle branch has: a pump for delivering a cleaning liquid from a cleaning liquid provided at the module liquid connection as a function of a pump control signal and for providing the delivered cleaning liquid in a liquid flow at a liquid nozzle line of the nozzle branch and a branch valve for pneumatically connecting the module compressed air connection to a compressed air nozzle line of the nozzle branch as a function of a valve control signal for providing a compressed air flow at the compressed air nozzle line in a ventilation position.

### CROSS-REFERENCE TO RELATED APPLICATIONS

This application is a continuation application of international patent application PCT/EP2021/068926, filed Jul. 8, 2021, designating the United States and claiming priority from German application 10 2020 119 475.7, filed Jul. 23, 2020, and the entire content of both applications is incorporated herein by reference.

### FIELD

The disclosure relates to a multi-channel cleaning device. Moreover, the disclosure relates to a multi-channel sensor cleaning module.

### BACKGROUND

Cleaning devices for vehicles, in particular for cleaning a number of surfaces, are generally known.

DE 101 10 490 A1 describes a device for controlling a fluid reservoir, in which it is provided that the fluid reservoir is divided into a working container and at least one reservoir container for refilling the working container. In an approach of this type, relatively high system costs arise due to the plurality of individual components.

Such approaches are in need of further improvement, in particular with respect to the reliable supply of multiple cleaning jets, in particular for cleaning multiple sensors or cameras with the lowest technical complexity possible.

It is an object of the disclosure to improve the function and the configuration of the cleaning device, in particular to enable a supply of multiple cleaning nozzles with relatively low technical complexity.

An object addressed by the disclosure is to provide an improved cleaning device, in which, in particular, a supply of multiple cleaning nozzles is enabled in an improved manner with relatively low technical complexity.

The object with respect to the cleaning device is, for example, achieved by the disclosure in a first aspect with a multi-channel cleaning device for providing at least one of a liquid flow and a compressed air flow for a number of cleaning jets. The multi-channel cleaning device includes: a module compressed air connection configured to receive compressed air; a module liquid connection configured to receive a cleaning liquid; at least two nozzle branches including a first nozzle branch configured to supply at least one cleaning nozzle independently of another of the at least two nozzle branches, wherein each of the at least two nozzle branches has: a pump configured to deliver cleaning liquid from the cleaning liquid provided at the module liquid connection as a function of a pump control signal and to provide the delivered cleaning liquid in a form of a liquid flow at a liquid nozzle line of the nozzle branch; and, a branch valve configured to pneumatically connect the module compressed air connection to a compressed air nozzle line of the nozzle branch as a function of a valve control signal for providing a compressed air flow at the compressed air nozzle line in a de-aerating position.

The disclosure is directed to a multi-channel cleaning device for providing a liquid flow and/or a compressed air flow for a number of cleaning nozzles, having:
a module compressed air connection for receiving compressed air,
a module liquid connection for receiving cleaning liquid.

According to the disclosure, in the multi-channel cleaning device, at least two nozzle branches are provided, wherein one nozzle branch is configured for supplying at least one cleaning nozzle independently of another nozzle branch, wherein each nozzle branch has:
a pump configured for delivering a cleaning liquid from a cleaning liquid provided at the module liquid connection, in particular without pressure, as a function of a pump control signal and for providing the delivered cleaning liquid in the form of a liquid flow, in particular under a delivery pressure, at a liquid nozzle line of the nozzle branch,
a branch valve configured for pneumatically connecting the module compressed air connection to a compressed air nozzle line of the nozzle branch as a function of a valve control signal for providing a compressed air flow at the compressed air nozzle line in an aerating position.

The disclosure is based on the finding that one possibility for supplying multiple cleaning nozzles is advantageous, in principle, with respect to the increased requirements on autonomous and semi-autonomous driving functions in a vehicle and the associated increased number of sensors, the cleaning of which is important for a reliable function.

In this regard, the disclosure has surprisingly recognized that it can be advantageous, in particular with respect to costs, weight, and/or susceptibility to failure, to provide a separate pump for each nozzle branch for delivering a cleaning liquid and providing the cleaning liquid in the form of a liquid flow. This finding is to be considered, in particular, against the background of conventional technically complex and costly approaches, in which a number of cleaning nozzles are connected via a relatively large central pump and a number of hydraulic and/or fluid valves.

The disclosure includes the finding that high requirements on a light weight, small installation space, and low costs prevail with respect to a vehicle. The disclosure also includes the finding that a cleaning device should be easy to repair, to service, and to retrofit.

Due to a central multi-channel cleaning device, a number of nozzle branches can be advantageously provided for independently supplying respective cleaning nozzles. As a result, all essential components that are required for suitably providing cleaning media, in particular a liquid flow and a compressed air flow, are provided in the form of a multi-channel cleaning device. Such a central multi-channel cleaning device is therefore advantageous as compared to other cleaning architectures, for example, pumps distributed in the vehicle for delivering cleaning liquid, in particular such that the multi-channel cleaning device can be installed, serviced, repaired, and/or retrofitted as a unit with relatively low effort.

In particular, a nozzle branch includes a liquid nozzle connection and a compressed air nozzle connection.

Within the scope of an embodiment, it is provided that the pump is configured as an electric pump, in particular as a washing water pump.

In particular a washing water pump, which is normally used in vehicles for delivering cleaning liquid, in particular, for windshield wiper systems and/or windshield cleaning systems, can be used as a cost-effective pump in the multi-channel cleaning device, in particular as a standard component that has a relatively low weight and dimensions and defined mechanical and control-related interfaces and is reliable.

Within the scope of a preferred embodiment, it is provided that the branch valve is configured as a 2/2-way valve, in particular as a 2/2-way solenoid valve. With a branch valve configured as a 2/2-way valve, in particular as a 2/2-way solenoid valve, the multi-channel cleaning device can be realized in a structurally simple and cost-effective way.

The cleaning liquid can be, in particular, water, or a mixture of water with cleaning agent and/or with antifreeze fluid.

In an embodiment having branch valves configured as 2/2-way valves, in particular as 2/2-way solenoid valves, the pump of a nozzle branch is preferably controlled via a pump control connection, and the branch valve is controlled independently thereof via a nozzle control connection, in particular to be able to provide the compressed air flow and the liquid flow independently of each other with respect to time. In particular, in this way, a sensor surface can be acted upon first by a liquid flow to soften, in particular dried, dirt particles, and, thereafter, by a compressed air flow to remove the softened dirt particles. It is also possible to repeat this sequence or to simultaneously act upon the sensor surface with a liquid flow and a compressed air flow or by other, simultaneous or consecutive sequences of one or multiple liquid flows and one or multiple compressed air flows.

Within the scope of an embodiment it is provided that the branch valve is configured as a 3/2-way valve, in particular as a 3/2-way solenoid valve, wherein the 3/2-way valve has a de-aerating connection and is configured for establishing a pneumatic connection between the compressed air nozzle line of the nozzle branch and the de-aerating connection. In a refinement of this type, in particular, a de-aeration of the compressed air nozzle line is enabled, in particular when means are provided in this liquid nozzle line for generating a compressed air cleaning pulse.

Within the scope of an embodiment it is provided that a quick vent valve is arranged in the compressed air nozzle line of the nozzle branch, the quick vent valve being configured for receiving the bypass compressed air flow and providing a compressed air cleaning pulse.

Within the scope of an embodiment, it is provided that all nozzle branches of the multi-channel cleaning device are identically configured. Within the scope of an embodiment, it is provided that the pumps of all nozzle branches of the multi-channel cleaning device are identically configured. Within the scope of an embodiment, it is provided that the branch valves of all nozzle branches of the multi-channel cleaning device are identically configured.

Within the scope of an embodiment, it is provided that, in the nozzle branch, the pump has a pump control connection and/or the branch valve has a valve control connection, which, in particular, are configured to be controllable independently of each other. The pump control connection and/or the valve control connection are/is configured to be connectable to a vehicle control line, in particular in a signal-routing manner in each case. Due to an independent controllability of the pump control connection and of the valve control connection, cleaning liquid and compressed air can be advantageously provided independently of each other for acting upon the sensor surface for cleaning. In particular, a cleaning can be carried out in an advantageously liquid-conserving manner only with compressed air, by providing only a compressed air flow.

In multi-channel cleaning devices that have nozzle branches including quick vent valves, such a refinement having pump control connections and valve control connections that are controllable independently of one another can include, in particular, a branch valve, which is configured as a normally open valve, in particular as a normally open 3/2-way valve. A “normally open valve” means that the valve, in this case the 3/2-way valve, is in its aerating position when in the non-activated, in particular non-energized condition, and is switched into its de-aerating position—de-aerating the quick vent valve at its second connection for emitting the compressed air cleaning pulse—only when a compressed air cleaning pulse is to be provided. In particular, the quick vent valve is arranged between the branch valve and the cleaning nozzle. In this way, in embodiments that include quick vent valves, an unnecessary activation, in particular an energization, of the branch valve is advantageously avoided over a long period of time.

In embodiments without quick vent valves, the branch valve can be preferably configured as a normally closed valve, in particular as a normally closed 2/2-way valve or 3/2-way valve. “Normally closed valve” therefore means that the valve, in particular the 3/2-way valve, is in its de-aerating position when in the non-activated, in particular non-energized, condition. Due to a normally closed branch valve is therefore advantageously activated, in particular energized, only for providing a compressed air flow.

Within the scope of an embodiment, it is provided that the pump and the branch valve of a nozzle branch have a common combination control connection, which combines a pump control connection of the pump and a valve control connection of the branch valve and is configured for jointly activating the pump and the branch valve of a particular nozzle branch with a single combination control signal. In a refinement of this type that includes a common combination control connection of a nozzle branch, the pump and the branch valve of a nozzle branch can be advantageously activated simultaneously, in particular with a control voltage. Such a refinement is advantageous, in particular, in multi-channel cleaning devices that have nozzle branches that include quick vent valves: Upon activation, in particular upon application of a control voltage, the pump of the nozzle branch is activated for providing a liquid flow and, simultaneously, compressed air is provided by switching the branch valve into the aerating position for filling the compressed air buffer of the quick vent valve. In the absence of the activation, in particular if the control voltage drops, the provision of the liquid flow and, thus, the application of cleaning liquid onto a sensor surface, is terminated and, simultaneously, due to a switching of the branch valve into the de-aerating position, a compressed air cleaning pulse is provided by the quick vent valve for acting upon the sensor surface with compressed air in an impulse-like manner. In this way, a cleaning of the sensor surface can be advantageously implemented with simplified control.

Within the scope of an embodiment, a central pump unit is provided, in which the pumps of multiple, in particular all, nozzle branches are arranged, in particular housed in a pump module. In a refinement of this type, the structural integration of the multi-channel cleaning device can be further improved by jointly arranging the pumps in a pump housing, in particular for achieving reduced installation space.

Within the scope of an embodiment, a module control connection is provided. Via a module control connection, the pump control connections and/or the valve control connections and/or the combination control connections can be advantageously provided in the form of an, in particular standardized, interface, which, in particular, simplifies assembly.

Within the scope of an embodiment, a module control unit is provided, which is configured for communication between the multi-channel cleaning device, in particular the module control connection of the multi-channel cleaning device, and a vehicle control unit of the vehicle, in particular via a vehicle bus. Alternatively or in addition to the module control connection, the module control unit can also be connected to pump control connections and/or valve control connections in a signal-routing manner.

In a second aspect, the disclosure yields a multi-channel sensor cleaning module including a module housing, in particular a valve cartridge housing, and a multi-channel cleaning device according to the first aspect of the disclosure. The advantages of the multi-channel cleaning device are therefore advantageously utilized in the multi-channel sensor cleaning module. In particular, the integration of the multi-channel cleaning device in the form of a closed multi-channel sensor cleaning module that includes defined interfaces and/or connections permits an improved integration into a vehicle, in particular with relatively little installation effort. A multi-channel sensor cleaning module of this type also enables, in an improved way, a retrofitting into existing vehicles. The module housing can be made of a suitable material, in particular of a plastic having sufficient strength, or of aluminum. A valve cartridge housing is formed, in particular of aluminum or plastic or a similarly suitable material, as a block into which a number of valve inserts has been introduced using suitable machining operations, including appropriate bores or similar air- and/or fluid-conveying lines between the valve inserts and/or external connections.

In a third aspect, the disclosure relates to a vehicle, in particular a passenger car or a commercial vehicle or a trailer, including at least one multi-channel cleaning device according to the first aspect of the disclosure and/or to a sensor cleaning module according to the second aspect of the disclosure. In a vehicle according to the third aspect of the disclosure, the advantages of the multi-channel cleaning device according to the first aspect of the disclosure and/or a sensor cleaning module according to the second aspect of the disclosure can be advantageously utilized. In particular, a reliable cleaning of sensor surfaces of the sensors of the vehicle by an improved multi-channel cleaning device according to the concept of the disclosure permits a more reliable function of driver assistance functions, autonomous driving functions, and/or semi-autonomous driving functions of the vehicle based on these sensors. The trailer can be configured, in particular, as a commercial vehicle trailer or a passenger car trailer.

### BRIEF DESCRIPTION OF DRAWINGS

The invention will now be described with reference to the drawings wherein:

FIG. 1 shows a multi-channel cleaning device according to the concept of the disclosure;

FIG. 1A shows, by way of example, a branch valve configured as a 2/2-way valve; and,

FIG. 2 shows a schematic representation of a vehicle including a multi-channel cleaning device according to the concept of the disclosure.

### DETAILED DESCRIPTION

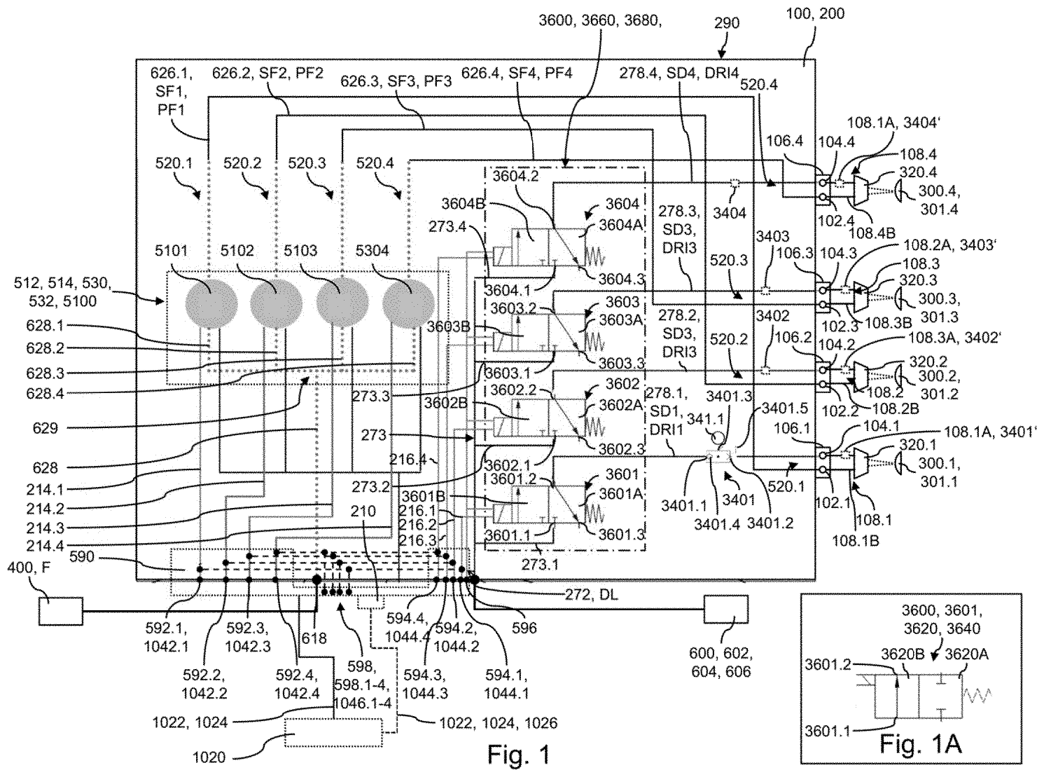

FIG. 1 shows a multi-channel cleaning device 100 according to the concept of the disclosure. The multi-channel cleaning device 100 in the present case has four nozzle branches 520.1, 520.2, 520.3, 520.4, wherein each nozzle branch 520.1, 520.2, 520.3, 520.4 is configured for providing a liquid flow SF1, SF2, SF3, SF4 and a compressed air flow SD1, SD2, SD3, SD4 for acting upon a sensor surface 300.1, 300.2, 300.3, 300.4 of a sensor 301.1, 301.2, 301.3, 301.4 for cleaning purposes.

The multi-channel cleaning device 100 has a module compressed air connection 272 for providing compressed air DL from a compressed air source 600, in particular from a compressor 602 and/or a compressed air reservoir 604 of a compressed air supply system 606.

Each nozzle branch 520 has a pump 5100 and a branch valve 3600. The first nozzle branch 520.1 has a first pump 5101. The first pump 5101 is configured for delivering cleaning liquid F, wherein the cleaning liquid F is provided via a module liquid connection 618, in particular without pressure. In particular, the module liquid connection 618 is connected in a fluid-conveying manner to a liquid source 400, in particular a water tank or a washing agent tank. In particular, the module liquid connection 618 can be connected in a fluid-conveying manner to an intake nozzle, which terminates within the water tank or washing agent tank, in particular at the base of the water tank or the washing agent tank. The module liquid connection 618 is connected in a fluid-conveying manner within the multi-channel cleaning device 100 to a module liquid line 628, which splits at a liquid distributor 629 in accordance with the number of nozzle branches 520, in the present case into a first liquid line 628.1, a second liquid line 628.2, a third liquid line 628.3, and a fourth liquid line 628.4. The first pump 5101 is configured for drawing in cleaning liquid F via the first liquid line 628.1 of the first nozzle branch 520.1, the module liquid line 628, and the module liquid connection 618, for delivering cleaning liquid F and, in particular, providing cleaning liquid F at a first liquid nozzle line 626.1 of the first nozzle branch 520.1, in particular under a first delivery pressure PF1, as the first liquid flow SF1. The first liquid nozzle line 626.1 is connected in a fluid-conveying manner to a first liquid nozzle connection 102.1 of the first nozzle branch 520.1.

The module compressed air connection 272 is pneumatically connected via a compressed air connection line 273 to a first compressed air connection line 273.1 of the first nozzle branch 520.1 extending to the first branch valve 3601, a second compressed air connection line 273.2 of the second nozzle branch 520.2 extending to the second branch valve 3602, a third compressed air connection line 273.3 of the third nozzle branch 520.3 extending to the third branch valve 3603, and a fourth compressed air connection line 273.4 of the fourth nozzle branch 520.4 extending to the fourth branch valve 3604.

The pumps 5100, in particular the pumps 5101, 5102, 5103, 5104 of all nozzle branches 520.1, 520.2, 520.3, 520.4, can preferably be configured as electric pumps 512, particularly preferably as washing water pumps 514. The delivery pressure PF can be, in particular, between 1.2 bar and 3.0 bar, preferably between 1.8 bar and 2.6 bar, particularly preferably 2.2 bar or 2.5 bar. The pumps 5100, in particular the pumps 5101, 5102, 5103, 5104 of all nozzle branches 520.1, 520.2, 520.3, 520.4, can preferably be housed together in a central pump unit 530 and/or together in a pump module 532.

The mode of operation is described in the following for the first nozzle branch 520.1 by way of example. The same applies for the remaining nozzle branches 520, in particular the second nozzle branch 520.2, the third nozzle branch 520.3, and the fourth nozzle branch 520.4.

The first pump 5101 is connected in a signal-routing manner via a first pump control line 214.1 of the first nozzle branch 520.1 to a first pump control connection 592.1 of the first nozzle branch 520.1 for receiving a first pump control signal 1042.1. The power of the first pump 5101 can be selectively set, in particular switched on or off, as a function of the first pump control signal 1042.1. The first pump control signal 1042.1 can be formed, in particular, as a control voltage.

The first nozzle branch 520.1 also includes a first branch valve 3601, which is configured for selectively providing a first compressed air flow SD1 at a first compressed air nozzle line 278.1 of the first nozzle branch 520.1. The first compressed air nozzle line 278.1 is pneumatically connected to a first compressed air nozzle connection 104.1 of the first nozzle branch 520.1.

The first branch valve 3601 is preferably configured as a 3/2-way valve 3660, particularly preferably as a 3/2-way solenoid valve 3680.

The first branch valve 3601 is connected in a signal-routing manner via a first valve control line 216.1 to a first valve control connection 594.1 for receiving a first valve control signal 1044.1.

The first branch valve 3601 is configured for blocking, in a first de-aerating or venting position 3601A, a first connection 3601.1, which is pneumatically connected to the module compressed air connection 272 via a first compressed air connection line 273.1, and connecting a second connection 3601.2, which is pneumatically connected to the first nozzle compressed air line 278.1, to a third de-aerating connection 3601.3 venting, in particular, into the surroundings.

The first branch valve 3601 is configured for blocking, in a second aerating position 3601B, the de-aerating connection 3601.3 and pneumatically connecting the first connection 3601.1 to the second connection 3601.2 of the first branch valve 3601. In the aerating position 3601B, the module compressed air connection 272 is therefore pneumatically connected to the first compressed air nozzle line 278.1 for providing a first compressed air flow SD1 at the first compressed air nozzle connection 104.1.

Via the first liquid nozzle connection 102.1 and the first compressed air nozzle connection 104.1 of the first nozzle branch 520.1, one or multiple cleaning nozzle(s) 320, in particular a first cleaning nozzle 320.1, can be connected, in order to direct the first liquid flow SF1 and/or the first compressed air flow SD1 provided by the first nozzle branch 520.1 onto a first sensor surface 300.1 of a first sensor 301.1 for cleaning purposes.

The multi-channel cleaning device 100 can have a nozzle connection line 108 in one or multiple nozzle branch(es) 520, the nozzle connection line 108 being configured for connecting one or multiple cleaning nozzle(s) 320 to the multi-channel cleaning device 100 in an air- and/or liquid-conveying manner. The nozzle connection line 108 can be configured as a common line, which is configured for conveying compressed air and cleaning liquid simultaneously and/or one after the other. In another embodiment, the nozzle connection line 108 can have a liquid nozzle connection line 108.1 and a compressed air nozzle connection line 108.2 and, thus, be configured for guiding the media separately to the cleaning nozzle 320. For example, the first nozzle branch 520.1 has a first nozzle connection line 108 that includes a first liquid nozzle connection line 108.1B and a first compressed air nozzle connection line 108.1A.

The first liquid nozzle connection 102.1 and the first compressed air nozzle connection 104.1 of the first nozzle branch 520.1 can be combined to form a first combination nozzle connection 106.1, which enables, in particular, a separate guidance of both media but also a common mechanical connection, in particular via screwing-in, snapping-in, or placing-on, the first cleaning nozzle 320.1 or a first nozzle connection line 108.1 with respect to the multi-channel cleaning device 100 and/or a multi-channel sensor cleaning module 200.

In embodiments in which, as shown here, the first branch valve 3601 is configured as a 3/2-way valve 3660, in particular as a 3/2-way solenoid valve 3680, a first quick vent valve 3401 can be optionally arranged, as a refinement, in the compressed air nozzle line 278.1, the first quick vent valve 3401 being configured for receiving the first compressed air flow SD1 and providing a first compressed air cleaning pulse DRI1.

The quick vent valve 3401 has a first connection 3401.1, which pneumatically connects the quick vent valve 3400 to the second connection 3601.2 of the first branch valve 3601. The first quick vent valve 3401 has a second connection 3401.2, which pneumatically connects the quick vent valve 3400 via the first compressed air nozzle line 278.1 to the first compressed air nozzle connection 104.1. The quick vent valve 3400 also has a third connection 3400.3, at which a first compressed air buffer 341.1 of the first quick vent valve 3401 is pneumatically connected. The first quick vent valve 3401 is formed in the manner of a selection valve including a first valve body 3401.4, which, with respect to the first connection 3401.1 and the second connection 3401.2, blocks the one at which the lower air pressure is present and pneumatically connects the particular other connection to the third connection 3401.3.

When, in an embodiment that includes a quick vent valve 3401, the first branch valve 3601 is switched into the aerating position 3601B, this results in compressed air DL present at the module compressed air connection 272 being delivered further to the first connection 3401.1 of the first quick vent valve 3401 in the form of the compressed air flow SD, as the result of which the first valve body 3401.4 is pressed in a blocking manner against the second connection 3401.2 and the first compressed air buffer 341.1 is filled with compressed air DL via the third connection 3401.3. If the branch valve 3601 is now switched into the de-aerating position 3601A, the second connection 3601.2 of the first branch valve 3601 is pneumatically connected to the de-aerating connection 3601.3 and the first connection 3601.1 is blocked. As a result, the air pressure at the first connection 3401.1 of the quick vent valve drops to an ambient pressure and the first valve body 3401.4 is pressed, in particular via a first quick vent valve control line 3401.5, by the pressure of the compressed air DL stored in the first compressed air buffer 341.1 in a blocking manner against the first connection 3401.1 of the first quick vent valve 3401. Consequently, the second connection 3401.2 of the first quick vent valve 3401 is opened, as the result of which the compressed air DL stored in the first compressed air buffer 341.1 can be provided at the first nozzle compressed air connection 104.1 in the form of the first compressed air cleaning pulse DRI1 via the second connection 3401.2 of the first quick vent valve 3401 and the first compressed air nozzle line 278.1.

In embodiments that include a first quick vent valve 3401, the first branch valve 3601 is configured, in particular, as normally open, that is, is in the aerating position 3601B when in a non-activated, in particular non-energized, condition. In this way, the first compressed air buffer 341.1, in the non-activated condition of the first branch valve 3601, is always acted upon by compressed air DL from the module compressed air connection 272, although delivery does not continue further to the first compressed air nozzle connection 104.1 due to the blocking of the first valve body 3401.4. A first compressed air cleaning pulse DRI1 is provided at the first compressed air nozzle connection 104.1 due to the above-described mode of operation of the quick vent valve 3401 only when the first branch valve 3601 is switched via activation into the de-aerating position 3601A.

With respect to the lowest possible pressure losses and, as a result, a strongest possible bypass compressed air cleaning pulse BDRI, it is advantageous to keep the line length between the quick vent valve 3401 and the cleaning nozzle 320 as short as possible. In alternative embodiments, instead of the first quick vent valve 3401 shown, an alternative further first quick vent valve 3401′ (shown highly simplified here) can be arranged closer to the cleaning nozzle 320, for example, between the first compressed air nozzle connection 104 and the first cleaning nozzle 320 in the first nozzle connection line 108, in particular in the first compressed air nozzle connection line 108.1A. The first cleaning nozzle 320.1, the first nozzle connection line 108, and the first quick vent valve 340 can be formed, in particular, as part of the multi-channel cleaning device 100.

As shown in FIG. 1A, in alternative embodiments of the disclosure, the branch valves 3600, in this case the first branch valve 3601 by way of example, can also be configured as a 2/2-way valve 3620, in particular as a 2/2-way solenoid valve 3640. In embodiments of this type, the first branch valve 3601 does not have a de-aerating connection 3601.3, and so the first branch valve 3601 is configured in these cases to pneumatically connect the first connection 3601.1 and the second connection 3601.2 in the aerating position 3601B, in particular an open position 3620B of the 2/2-way valve 3620, and to pneumatically disconnect the first connection 3601.1 and the second connection 3601.2 in the de-aerating position, in particular a blocking position 3620A of the 2/2-way valve 3620, 3601A. In embodiments in which the first branch valve 3601 is configured as a 2/2-way valve 3620, the first branch valve 3601 is preferably configured as a normally closed valve, that is, the branch valve 3601 is in its blocking position 3620A when in the non-activated, in particular non-energized or currentless condition, and in its open position 3620B for providing a compressed air flow SD when in the activated, in particular energized, condition.

The first pump control connection 592.1 and the first valve control connection 594.1 of the first nozzle branch 520.1 can—as explicitly shown in FIG. 1 for illustration only for the first nozzle branch 520.1, but possible for all nozzle branches 520.1-4—be combined in particular in the form of a common combination control connection 598.1, in particular for jointly activating the first pump 5101 and the first branch valve 3601 of the first nozzle branch via a first combination control signal 1046.1.

The entirety of the preceding comments presented in detail for the first nozzle branch 520.1 apply similarly for further nozzle branches 520, in particular the components (correspondingly numbered here) of the second nozzle branch 520.2, of the third nozzle branch 520.3, and of the fourth nozzle branch 520.4.

In some embodiments, all nozzle branches of the multi-channel cleaning device 100 can be identically configured. Nevertheless, however, differently configured nozzle branches can be provided in a multi-channel cleaning device 100 within the scope of the disclosure.

The multi-channel cleaning device 100 can have a module control connection 590, which provides, in particular, the pump control connections 592.1, 592.2, 592.3, 592.4 and the valve control connections 594.1, 594.2, 594.3, 594.4 in a combined manner, in particular in the form of a uniform plug or a row of individual plugs arranged next to one another. Via a module control connection 590, the multi-channel cleaning device 100 can be connected in a signal-routing manner to a vehicle control unit 1020 for exchanging control signals 1022, in particular via a vehicle control line 1024.

Alternatively or additionally, the multi-channel cleaning device 100 can have a module control unit 210, which is configured to be connectable in a signal-routing manner to the vehicle control unit 1020 of the vehicle 1000, in particular via a vehicle control line 1024, which is configured as a vehicle bus 1026. The module control unit 210 is used, in particular, as an interface between the cleaning device 100—in particular pump control connections 592.1, 592.2, 592.3, 592.4 and/or valve control connections 594.1, 594.2, 594.3, 594.4 and/or the module control connection 590—and the vehicle control unit 1020 and enables a signal-routing communication via the vehicle bus 1026 in a suitable protocol, in particular CAN. In particular, the vehicle bus 1026 of the vehicle 1000 is configured as a CAN bus.

The module control connection 590 can, in particular within the scope of the electrical supply and/or activation, also have a ground connection 596, in particular a common ground connection 596 for all pumps 5101, 5102, 5103, 5104 and branch valves 3601, 3602, 3603, 3604 of the multi-channel cleaning device 100.

The multi-channel cleaning device 100 shown in FIG. 1 can be housed in a module housing 290 for forming a multi-channel sensor cleaning module 200. The module housing 290 can be made of a suitable material, in particular of a plastic having sufficient strength, or of aluminum.

An optional second quick vent valve 3402, an optional third quick vent valve 3403, and an optional fourth quick vent valve 3404 are shown in FIG. 1 merely in a highly simplified manner. The comments presented with respect to the first quick vent valve 3401, in particular with similarly numbered reference characters, apply in this regard.

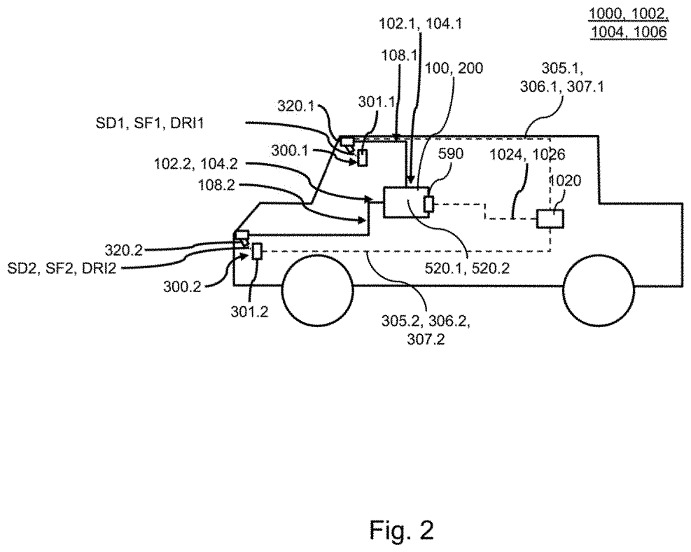

FIG. 2 shows a schematic representation of a vehicle 1000, in particular of a passenger car 1002 or a commercial vehicle 1004—in the present case in the form of an autonomous or semi-autonomous vehicle—including a multi-channel cleaning device 100 having a number of nozzle branches 520 for a number of at least two cleaning nozzles 320, in the present case having a first nozzle branch 520.1 for a first cleaning nozzle 320.1 for cleaning a first sensor surface 300.1 of a first sensor 301.1 configured as an optical sensor, for example, as a camera, and having a second nozzle branch 520.2 for a second cleaning nozzle 320.2 for cleaning a second sensor surface 300.2 of a second sensor 301.2 configured as an optical sensor, for example, as a camera. Nevertheless, a use of the multi-channel cleaning device 100 in other vehicles is possible.

The multi-channel cleaning device 100 is configured, in particular, as a sensor cleaning module 200. The cleaning device 100 has a module control connection 590, which is connected in a signal-routing manner to a vehicle control unit 1020 via a vehicle control line 1024. The vehicle control line 1024 is configured, in particular, as a vehicle bus 1026, in particular a CAN bus.

The first sensor 301.1 is connected in a signal-routing manner to the vehicle control unit 1020 via a first signal line 306.1 for transmitting first sensor signals 305.1. In particular, a first cleaning check signal 307.1 for determining whether a first liquid cleaning pulse FRI1 has been output can be transmitted to the vehicle control unit 1020 via the first sensor line 306.1. Similarly, the second sensor 301.2 is connected in a signal-routing manner to the vehicle control unit 1020 via a second sensor line 106.2 for transmitting second sensor signals 305.2, in particular a second cleaning check signal 307.2.

In the case of a sensor 301.1, 301.2 configured as a camera, in particular having means for image recognition, a cleaning check signal 307.1, 307.2 can be generated, for example, due to the detection of liquid particles in the camera image. Alternatively or additionally, a cleaning check signal 307.1, 307.2 can be generated by way of a current consumption of the pump and/or of the branch valve of the particular nozzle branch being evaluated.

The cleaning nozzles 320.1, 320.2 are configured for acting upon the sensor surface 300.1, 300.2, respectively, with a liquid flow SF1, SF2 and/or a compressed air flow SD1, SD2 and/or a compressed air cleaning pulse DRI1, DRI2.

Each cleaning nozzle 320.1, 320.2 is connected in a fluid-conveying manner to the multi-channel cleaning device 100 via a nozzle liquid connection 102.1, 102.2 and a nozzle compressed air connection 104.1, 104.2. In embodiments in which the cleaning nozzle 320 is not arranged directly at the cleaning device 100 or the sensor cleaning module 200, the cleaning nozzle 320 can be connected in a fluid-conveying manner via a nozzle connection line 108.1, 108.2 to the nozzle liquid connection 102 and/or the nozzle compressed air connection 104.

It is understood that the foregoing description is that of the preferred embodiments of the invention and that various changes and modifications may be made thereto without departing from the spirit and scope of the invention as defined in the appended claims.

100 multi-channel cleaning device

102 liquid nozzle connection

102.1-4 first through fourth liquid nozzle connection

104 compressed air-compressed air connection

104.1-4 first through fourth compressed air-compressed air connection

106 combination nozzle connection

106.1-4 first through fourth combination nozzle connection

108 nozzle connection line

108.1-4 first through fourth nozzle connection line

108A compressed air nozzle connection line

108.1-4A first through fourth compressed air nozzle connection line

108B liquid nozzle connection line

108.1-4B first through fourth liquid nozzle connection line

200 sensor cleaning module

210 module control unit

214 pump control line

214.1-4 first through fourth pump control line

216 valve control line

216.1-4 first through fourth valve control line

272 module compressed air connection

273 compressed air connection line

273.1-4 first through fourth compressed air connection line

278 compressed air nozzle line

290 module housing

300 sensor surface

300.1-4 first through fourth sensor surface

301 sensor

301.1-4 first through fourth sensor

305 sensor signal

305.1, 305.2 first, second sensor signal

306 sensor line

306.1, 306.2 first, second sensor line

307 cleaning check signal

307.1, 307.2 first, second cleaning check signal

320 cleaning nozzle

320.1-4 first through fourth cleaning nozzle

341 compressed air buffer

400 liquid source

512 electric pump

514 washing water pump

530 central pump unit

532 pump module

520 nozzle branch

520.1-4 first through fourth nozzle branch

590 module control connection

592 pump control connection

592.1-4 first through fourth pump control connection

594 valve control connection

594.1-4 first through fourth valve control connection

596 ground connection

598 combination control connection

598.1-4 first through fourth combination control connection

600 compressed air source

602 compressor

604 pressure reservoir

606 compressed air supply system

626 liquid nozzle line

626.1-4 first through fourth liquid nozzle line

628 module liquid line

628.1-4 first through fourth module liquid line

629 liquid distributor

1000 vehicle

1002 passenger car

1004 commercial vehicle

1006 trailer

1020 vehicle control unit

1024 vehicle control line

1026 vehicle bus

1042 pump control signal

1042.1-4 first through fourth pump control signal

1044 valve control signal

1044.1-4 first through fourth valve control signal

1046 combination control signal

1046.1-4 first through fourth combination control signal

3400 quick vent valve

3401 first quick vent valve

3401.1 first connection of the first quick vent valve

3401.2 second connection of the first quick vent valve

3401.3 third connection of the first quick vent valve

3401.4 valve body of the first quick vent valve

3401.5 quick vent valve control line of the first quick vent valve

3402 second quick vent valve

3402.1 first connection of the second quick vent valve

3402.2 second connection of the second quick vent valve

3402.3 third connection of the second quick vent valve

3402.4 valve body of the second quick vent valve

3402.5 quick vent valve control line of the second quick vent valve

3403 third quick vent valve

3403.1 first connection of the third quick vent valve

3403.2 second connection of the third quick vent valve

3403.3 third connection of the third quick vent valve

3403.4 valve body of the third quick vent valve

3403.5 quick vent valve control line of the third quick vent valve

3404 fourth quick vent valve

3404.1 first connection of the fourth quick vent valve

3404.2 second connection of the fourth quick vent valve

3404.3 third connection of the fourth quick vent valve

3404.4 valve body of the fourth quick vent valve

3404.5 quick vent valve control line of the fourth quick vent valve

3600 branch valve

3601 first branch valve

3601.1 first connection of the first branch valve

3601.2 second connection of the first branch valve

3601.3 de-aerating connection of the first branch valve

3601A de-aerating position of the first branch valve

3601B aerating position of the first branch valve

3602 second branch valve

3602.1 first connection of the second branch valve

3602.2 second connection of the second branch valve

3602.3 de-aerating connection of the second branch valve

3602A de-aerating position of the second branch valve

3602B aerating position of the second branch valve

3603 third branch valve

3603.1 first connection of the third branch valve

3603.2 second connection of the third branch valve

3603.3 de-aerating connection of the third branch valve

3603A de-aerating position of the third branch valve

3603B aerating position of the third branch valve

3604 fourth branch valve

3604.1 first connection of the fourth branch valve

3604.2 second connection of the fourth branch valve

3604.3 de-aerating connection of the fourth branch valve

3604A de-aerating position of the fourth branch valve

3604B aerating position of the fourth branch valve

3620 2/2-way valve

3620A blocking position of the 2/2-way valve

3620B open position of the 2/2-way valve

3640 2/2-way solenoid valve

3660 3/2-way valve

3680 3/2-way solenoid valve

DL compressed air

DRI compressed air cleaning pulse

DRI1-4 first through fourth compressed air cleaning pulse

F cleaning liquid

PF delivery pressure

PF1-4 first through fourth delivery pressure

SD compressed air flow

SD1-4 first through fourth compressed air flow

SF liquid flow

SF1-4 first through fourth liquid flow

1. A multi-channel cleaning device for providing at least one of a liquid flow and a compressed air flow for a number of cleaning jets, the multi-channel cleaning device comprising:
a module compressed air connection configured to receive compressed air;
a module liquid connection configured to receive a cleaning liquid;
at least two nozzle branches including a first nozzle branch configured to supply at least one cleaning nozzle independently of another of said at least two nozzle branches, wherein each of said at least two nozzle branches has:
a pump configured to deliver cleaning liquid from the cleaning liquid provided at said module liquid connection as a function of a pump control signal and to provide the delivered cleaning liquid in a form of a liquid flow at a liquid nozzle line of said nozzle branch; and,
a branch valve configured to pneumatically connect the module compressed air connection to a compressed air nozzle line of said nozzle branch as a function of a valve control signal for providing a compressed air flow at said compressed air nozzle line in a de-aerating position.

2. The multi-channel cleaning device of claim 1, wherein said pump is an electric pump.

3. The multi-channel cleaning device of claim 1, wherein said branch valve is configured as at least one of a 2/2-way valve and a 2/2-way solenoid valve.

4. The multi-channel cleaning of claim 1, wherein said branch valve is configured as a 3/2-way valve; and, said 3/2-way valve has a vent connection and is configured to establish a pneumatic connection between said compressed air nozzle line of said nozzle branch and said vent connection.

5. The multi-channel cleaning device of claim 4, wherein each of said at least two nozzle branches further has a quick vent valve arranged in said compressed air nozzle line of said nozzle branch or in the compressed air nozzle connection line pneumatically connecting the at least one cleaning nozzle to said compressed air nozzle line; and, said quick vent valve being configured to receive a bypass compressed air flow and to provide a compressed air cleaning pulse.

6. The multi-channel cleaning device of claim 1, wherein, in said first nozzle branch, said pump has a pump control connection and the branch valve has a valve control connection.

7. The multi-channel cleaning device of claim 6, wherein said pump control connection and said valve control connection are configured to be controllable independently of one another.

8. The multi-channel cleaning device of claim 1, wherein said pump and said branch valve of said first nozzle branch have a common combination control connection, which combines a pump control connection of said pump and a valve control connection of said branch valve and is configured for jointly activating said pump and said branch valve of said first nozzle branch with a single combination control signal.

9. The multi-channel cleaning device of claim 1 further comprising a central pump unit; and, said pumps of all of said at least two nozzle branches being arranged in said central pump unit.

10. The multi-channel cleaning device of claim 9, wherein said pumps are housed in a pump module.

11. The multi-channel cleaning device of claim 1 further comprising a module control connection.

12. The multi-channel cleaning device of claim 1 further comprising a module control unit configured for communication between the multi-channel cleaning device and a vehicle control unit of the vehicle.

13. The multi-channel cleaning device of claim 12 further comprising a module control connection;
and, said module control unit being configured for communication between said module control connection of the multi-channel cleaning device and the vehicle control unit.

14. The multi-channel cleaning device of claim 13, wherein said module control unit is configured for communication between said module control connection and the vehicle control unit via a vehicle bus.

15. The multi-channel cleaning device of claim 1, wherein the cleaning liquid is provided at said module liquid connection without pressure.

16. The multi-channel cleaning device of claim 2, wherein said electric pump is a washing water pump.

17. The multi-channel cleaning of claim 4, wherein said 3/2 way valve is a 3/2-way solenoid valve.

18. A multi-channel sensor cleaning module comprising:
a module housing;
a multi-channel cleaning device for providing at least one of a liquid flow and a compressed air flow for a number of cleaning jets;
said multi-channel cleaning device including a module compressed air connection configured to receive compressed air and a module liquid connection configured to receive a cleaning liquid;
said multi-channel cleaning device further including at least two nozzle branches including a first nozzle branch configured to supply at least one cleaning nozzle independently of another of said at least two nozzle branches, wherein each of said at least two nozzle branches has:
a pump configured to deliver cleaning liquid from the cleaning liquid provided at said module liquid connection as a function of a pump control signal and to provide the delivered cleaning liquid in a form of a liquid flow at a liquid nozzle line of said nozzle branch; and,
a branch valve configured to pneumatically connect the module compressed air connection to a compressed air nozzle line of said nozzle branch as a function of a valve control signal for providing a compressed air flow at said compressed air nozzle line in a de-aerating position.

19. The multi-channel sensor cleaning module of claim 18 wherein said module housing is a valve cartridge housing.

20. A vehicle comprising:
at least one of a multi-channel cleaning device and a multi-channel sensor cleaning module, wherein said multi-channel sensor cleaning module includes a module housing and said multi-channel cleaning device;
said multi-channel cleaning device including a module compressed air connection configured to receive compressed air and a module liquid connection configured to receive a cleaning liquid;
said multi-channel cleaning device further including at least two nozzle branches including a first nozzle branch configured to supply at least one cleaning nozzle independently of another of said at least two nozzle branches, wherein each of said at least two nozzle branches has:
a pump configured to deliver cleaning liquid from the cleaning liquid provided at said module liquid connection as a function of a pump control signal and to provide the delivered cleaning liquid in a form of a liquid flow at a liquid nozzle line of said nozzle branch; and,
a branch valve configured to pneumatically connect the module compressed air connection to a compressed air nozzle line of said nozzle branch as a function of a valve control signal for providing a compressed air flow at said compressed air nozzle line in a de-aerating position.

21. The vehicle of claim 20, wherein the vehicle is a passenger car, a commercial vehicle, or a trailer.
